(19) United States
(12) Patent Application Publication
(10) Pub. No.: US 2021/0347945 A1
(43) Pub. Date: Nov. 11, 2021

(54) VEHICLE INTERIOR COMPONENT WITH POLYMER COMPOSITION

(71) Applicant: Shanghai Yanfeng Jinqiao Automotive Trim Systems Co. Ltd., Novi, MI (US)

(72) Inventors: Liyong Wang, Shanghai (CN); Jie Sun, Shanghai (CN)

(21) Appl. No.: 17/382,704

(22) Filed: Jul. 22, 2021

Related U.S. Application Data
(63) Continuation-in-part of application No. PCT/CN2020/073741, filed on Jan. 22, 2020.

(30) Foreign Application Priority Data
Jan. 23, 2019 (CN) 201910063271.4

(51) Int. Cl. C08G 67/02; B29C 45/00; C08K 7/14; C08L 73/00

(52) U.S. Cl. CPC C08G 67/02; B29C 45/0005; B29K 2309/08; C08K 7/14; C08L 73/00; B29C 45/0001

(57) ABSTRACT

A component for a vehicle interior is disclosed. The component may be formed from a composition comprising polyketone resin in a range of less than about 40 percent by weight, compatible resin, copolymer, compatibilizer and reinforcing material. An effect on a surface of the component is provided by the composition as a result of crystallinity and half-time of crystallization. The composition may provide crystallinity above about 15 percent and half-time crystallization above about 42 seconds. The component may provide crystallinity in a range of between about 17 to 26 percent. The effect provided by crystallinity and crystallization rate of the composition may comprise a substantially consistent visual effect at the surface of the component. The composition may comprise a polyketone composite material. A method of forming the component providing the crystallinity for the visual surface effect from the composition in a tool as a molded part is also disclosed.

### CROSS-REFERENCE TO RELATED APPLICATIONS

The present application is a continuation-in-part of PCT/International Patent Application No. PCT/CN2020/073741 titled “VEHICLE INTERIOR COMPONENT WITH POLYMER COMPOSITION” filed Jan. 22, 2020, which claims the benefit of Chinese Patent Application No. 201910063271.4 filed Jan. 23, 2019 (Chinese Patent Application Publication No. CN109852033A).

The present application claims priority to and incorporates by reference in full the following patent applications: (a) Chinese Patent Application No. 201910063271.4 filed Jan. 23, 2019 (Chinese Patent Application Publication No. CN109852033A); (b) PCT/International Patent Application No. PCT/CN2020/073741 titled “VEHICLE INTERIOR COMPONENT WITH POLYMER COMPOSITION” filed Jan. 22, 2020.

### FIELD

The present invention relates to a vehicle interior component with an improved polymer composition.

### BACKGROUND

It is known to produce aliphatic polyketone material prepared by polymerizing ethylene, propylene and carbon monoxide and with a regular linear structure; the material is characterized by simple synthetic raw materials and the capacity of consuming carbon monoxide (e.g. and thus considered as an environment-friendly material). The polyketone product has better dimensional stability. The polyketone has fluidity adjustable in a large range, and good impact performance and wear resistance. The polyketone material can be used as an injection molded piece for automotive interiors as a substitution of some nylon materials. In order to use a polyketone material as a load-bearing automotive interior injection molded piece, a reinforcing material is required as a filler and for reinforcement (e.g. fibers such as glass fibers, carbon fibers and the like are generally used). A relatively large crystallinity and relatively fast crystallization rate of the polyketone material may improve the mechanical properties and shorten the processing period of the material but may cause the surface to form/solidify more quickly; and consequently reinforcing materials such as glass fibers are more likely to be visible at the surface layer (e.g. visible fiber emergence, which adversely affects the appearance of the injection molded piece and that may require treatment of the surface such as by painting, spraying, etc.).

It would be advantageous to provide an improved vehicle interior component with an improved polymer composite to present suitable mechanical properties and an acceptable effect/visual appearance at the surface without requiring treatment which may be achieved by desired/qualified values of crystallinity and crystallization rate (defined as reciprocal of half crystallization time) of the polymer composition correlated to the acceptable effect/appearance.

### SUMMARY

The present invention relates to a component for a vehicle interior configured to provide a surface and formed from a composition comprising polyketone resin in a range of less than about 40 percent by weight, compatible resin, copolymer, compatibilizer and reinforcing material. The composition may provide a crystallinity above about 15 percent and a half-time crystallization above about 42 seconds so that an effect on the surface is provided by the composition as a result of the crystallinity and the half-time of crystallization. The component may provide crystallinity in a range of between about 17 to 26 percent. The component may provide half-time of crystallization of between about 42 and 51 seconds. The effect on the surface may be provided by crystallinity and a crystallization rate of the composition; the effect may comprise a substantially consistent visual effect at the surface. The crystallization rate may be characterized by the reciprocal half-time of crystallization for formation of the composition. The composition may comprise polyketone resin in a range between about 25 to 40 percent by weight. The composition may comprise compatible resin in a range of less than about 10 percent by weight. The composition may comprise polyketone resin in a range of between about 31 to 39 percent by weight. The composition may comprise compatible resin in a range of between about 1 to 10 percent by weight. The composition of the component may comprise copolymer in a range of less than about 5 percent by weight. The composition of the component may comprise compatibilizer in a range of greater than about 1 percent by weight. The composition may comprise polyketone resin in a range of between about 31 to 39 percent by weight, compatible resin in a range of between about 1 to 10 percent by weight, copolymer in a range of between about 1 to 5 percent by weight, compatibilizer in a range of between about 2 to 5 percent by weight. The composition may comprise reinforcing material in a range of between about 40 and 60 percent by weight. The composition may comprise less than about 1 percent by weight polyamide 6 (PA6). The composition may comprise a polyketone composite material.

The present invention relates to a method of producing of an injection-molded component providing a surface from a composition in a mold comprising the steps of providing a polyketone resin comprising an aliphatic polyketone, adding the polyketone resin, a compatible resin, a copolymer resin, a compatibilizer and a reinforcing material into an extruder for polyketone modification to provide a reinforced polyketone composite material for the composition, adding the reinforced polyketone composite material into the mold and forming the injection-molded component from the composition in the mold. The compatible resin may be a resin providing compatibility with the polyketone resin. Mass ratio of the polyketone resin may be about 15 to 90 percent by weight, mass ratio of the compatible resin may be about 1 to 10 percent weight, mass ratio of the copolymer resin may be about 1 to 10 percent by weight, mass ratio of the compatibilizer may be about 1 to 5 percent by weight and mass ratio of the reinforcing material may be about 5 to 60 percent by weight so that an effect on the surface of the injection-molded component is provided by the composition as a result of crystallinity and crystallization rate. Crystallization rate may be characterized by reciprocal of half-time of crystallization. Mass ratio of the polyketone resin may be about 25 to 44 percent by weight and mass ratio of the compatible resin may be about 1 to 10 percent by weight and mass ratio of the copolymer resin may be about 1 to 5 percent by weight and mass ratio of the compatibilizer may be about 1 to 5 percent and mass ratio of the reinforcing material may be about 45 to 55 percent by weight. The composition may comprise glass fiber; crystallization rate may be selected to reduce glass fiber exposure in the composition. The compatibilizer may comprise a polyolefin grafted glycidyl methacrylate. Crystallinity may be determined in an isothermal measurement at 185 degrees Centigrade.

The present invention relates to a component for a vehicle interior configured to provide a surface and formed from a composition comprising by mass fraction in percent by weight: polyketone resin in a range of less than about 40 percent by weight, compatible resin, copolymer, compatibilizer and reinforcing material. The component may be formed from the composition to provide a crystallinity above about 15 percent and to provide a half-time crystallization above about 42 seconds so that an effect on the surface is provided by the composition as a result of the crystallinity, the crystallization rate and the half-time of crystallization. Crystallinity may be determined in an isothermal measurement at 185 degrees Centigrade. The component may provide a crystallinity in a range of between about 17 to 26 percent. The component may provide a half-time of crystallization of between about 42 and 51 seconds. The effect on the surface may be provided by the crystallinity and the crystallization rate of the composition. The effect may comprise a visual surface effect. The effect may comprise a visual appearance. The visual appearance may comprise a substantially consistent surface effect. The effect may comprise a substantially consistent visual effect at the surface. The crystallization rate may be characterized by the reciprocal half-time of crystallization for formation of the composition. The composition may comprise polyketone resin in a range of less than about 40 percent by weight. The composition may comprise compatible resin in a range of less than about 10 percent by weight. The composition may comprise polyketone resin in a range of between about 31 to 39 percent by weight. The composition may comprise compatible resin in a range of between about 1 to 10 percent by weight. The composition of the component may comprise copolymer in a range of less than about 5 percent by weight. The composition of the component may comprise compatibilizer in a range of greater than about 1 percent by weight. The composition may comprise polyketone resin in a range of between about 31 to 39 percent by weight. The composition may comprise compatible resin in a range of between about 1 to 10 percent by weight. The composition of the component may comprise copolymer in a range of between about 1 to 5 percent by weight. The composition of the component may comprise compatibilizer in a range of between about 2 to 5 percent by weight. The composition may be mixed in an extrusion machine. The composition may be formed in a mold. The composition may be formed in a mold configured to be maintained at a temperature in a range of between about 110 to 140 degrees Centigrade. The component may be formed in a mold operated at a temperature in a range of between about 110 to 140 degrees Centigrade. The component may be formed in a mold configured to be maintained at a temperature in a range of between about 125 to 135 degrees Centigrade. The component may be formed in a mold providing a surface effect; the effect at the surface provided by the composition may comprise a visual effect generally resembling the surface effect of the mold. The component may be formed as a molded component. The component may be formed as an injection-molded component. The composition may comprise a polymer material. The composition may comprise a polyketone composite material. The composition may comprise a resin material. The composition may comprise a resin matrix. The composition may comprise a resin matrix and a fiber material. The composition may comprise a fiber-reinforced composite material. The composition may comprise reinforcing material in a range of between about 40 and 60 percent by weight. The composition may comprise reinforcing material of at least 50 percent by weight. The reinforcing material may comprise a fiber material. The fiber material may comprise glass fiber. The crystallization rate may be configured to reduce glass fiber exposure in the composition. The composition may comprise toner. The composition may comprise lubricant. The composition may comprise optional antioxidant. The composition may comprise optional light stabilizer. The composition may comprise optional antioxidant of about 0.3 percent by weight. The composition may comprise a combined mass fraction of compatible resin and copolymer no greater than 20 percent of total mass by weight. The compatible resin may comprise amorphous polyamide. The composition may comprise less than about 1 percent by weight polyamide 6 (PA6). The component may be formed as an injection-molded piece.

The present invention relates to a method of producing of an injection molded component comprising the steps of providing a polyketone resin which is an aliphatic polyketone and adding the polyketone resin, a compatible resin, a copolymer resin, a compatibilizer and a reinforcing material into an extruder for polyketone modification to provide reinforced polyketone composite particles. The compatible resin may be a resin with good compatibility with the polyketone resin. Mass ratio of the polyketone resin may be about 15 to 90 percent weight; mass ratio of the compatible resin may be about 1 to 10 percent weight; mass ratio of the copolymer resin may be about 1 to 10 percent weight; mass ratio of the compatibilizer may be about 1 to 5 percent weight; mass ratio of the reinforcing material may be about 5 to 60 percent weight. The method may comprise adding the reinforced polyketone composite material particles into a mold for molding to form an injection molded part. Mass ratio of the polyketone resin may be about 25 to 44 percent by weight and mass ratio of the compatible resin may be about 1 to 10 percent by weight and mass ratio of the copolymer resin may be about 1 to 5 percent by weight and mass ratio of the compatibilizer may be about 1 to 5 percent and mass ratio of the reinforcing material may be about 45 to 55 percent by weight. The compatible resin may be an ester resin or an amide resin. The compatible resin may be an amorphous polyester or an amorphous polyamide. The copolymer resin may be a methyl methacrylate copolymer. The compatibilizer may be a polyolefin grafted glycidyl methacrylate. The reinforcing material may be a powdery mineral or a fiber reinforcing material. The reinforcing material may be surface-treated with a polar coating. The method may comprise the step of modifying the polyketone resin by adding an antioxidant and/or a light stabilizer and/or a lubricant and/or a toner into the extruder. The extruder may comprise a twin-screw extruder.

The present invention relates to a preparation method of an injection molded piece comprising the steps of providing a polyketone resin comprising an aliphatic polyketone and adding the polyketone resin, a compatible resin, a copolymer resin, a compatibilizer and a reinforcing material into an extruder for polyketone modification to provide reinforced polyketone composite particles. The compatible resin may be a resin with good compatibility with the polyketone resin. The copolymer resin may be a methyl methacrylate copolymer. The mass ratio of the polyketone resin may be about 31 to 39 percent by weight. The mass ratio of the compatible resin may be about 1 to 10 percent by weight. The mass ratio of the copolymer resin may be about 1 to 10 percent by weight. The mass ratio of the compatibilizer may be about 1 to 5 percent by weight. The mass ratio of the reinforcing material may be about 2 to 50 percent by weight. The compatible resin may have a first molecular weight; the copolymer resin may have a second molecular weight; the compatilizer may have a third molecular weight; the first molecular weight may be greater than the second molecular weight; the second molecular weight may be greater than the third molecular weight. The compatible resin may pass through physical barriers to reduce the generation of large crystals of the polyketone resin. The copolymer resin may prevent generation of small crystals of the polyketone resin. The compatibilizer may enter the polyketone molecular chain segment of the small space of the polyketone resin to prevent the generation of microcrystals of the polyketone resin. The method may comprise adding reinforced polyketone composite material particles into a mold for molding to form an injection molded piece. The compatible resin may be an ester resin or an amide resin. The compatible resin may be an amorphous polyester or an amorphous polyamide. The compatibilizer may be a polyolefin grafted glycidyl methacrylate. The reinforcing material may be a powdery mineral or a fiber reinforcing material. The reinforcing material may be surface-treated with a polar coating. The step of modifying the polyketone resin may comprise adding an antioxidant and/or an anti-light adjuvant and/or a lubricant and/or a toner into the extruder. The extruder may be a twin-screw extruder.

The present invention relates to a component for a vehicle interior configured to provide a surface and formed from a composition comprising by mass fraction in percent polyketone resin in a range of less than about 40 percent; compatible resin; copolymer; compatibilizer; reinforcing material. The component is formed from the composition to provide a crystallinity above about 15 percent; formed from the composition to provide half-time of crystallization above about 42 seconds; so that an effect on the surface is provided by the composition as a result of the crystallinity and the crystallization rate. The component may be formed from the composition to provide a crystallinity in a range of between about 17 to 26 percent. The component may be formed from the composition to provide half-time of crystallization between about 42 and 51 seconds. The effect on the surface may be provided by the crystallinity and the crystallization rate of the composition. The effect may comprise a visual surface effect. The effect may comprise a visual appearance. The visual appearance may comprise a substantially consistent surface effect. The effect may comprise a substantially consistent visual effect at the surface. The crystallization rate may comprise a half-crystallization time for formation of the composition. The composition of the component may comprise polyketone resin in a range of less than about 40 percent. The composition of the component may comprise compatible resin in a range of less than about 10 percent. The composition of the component may comprise polyketone resin in a range of between about 31 to 39 percent. The composition of the component may comprise compatible resin in a range of between about 1 to 10 percent. The composition of the component may comprise copolymer in a range of less than about 5 percent. The composition of the component may comprise compatibilizer in a range of greater than about 1 percent. The composition of the component may comprise polyketone resin in a range of between about 31 to 39 percent; the composition may comprise compatible resin in a range of between about 1 to 10 percent; the composition of the component may comprise copolymer in a range of between about 1 to 5 percent; the composition of the component may comprise compatibilizer in a range of between about 2 to 5 percent. The composition may be mixed in an extrusion machine. The composition may be formed in a mold. The composition may be formed in a mold configured to be maintained at a temperature in a range of between about 110 to 140 degrees Centigrade. The component may be formed in a mold operated at a temperature in a range of between about 110 to 140 degrees Centigrade. The component may be formed in a mold configured to be maintained at a temperature in a range of between about 125 to 135 degrees Centigrade. The component may be formed in a mold providing a surface effect; the effect at the surface provided by the composition may comprise a visual effect generally resembling the surface effect of the mold. The component may be formed as a molded component. The component may be formed as an injection-molded component. The composition of the component may comprise a polymer material. The composition of the component may comprise a polyketone composite material. The composition of the component may comprise a resin material. The composition of the component may comprise a resin matrix. The composition of the component may comprise a resin matrix and a fiber material. The composition of the component may comprise a fiber-reinforced composite material. The composition of the component may comprise reinforcing material in a range of between about 40 and 60 percent. The composition of the component may comprise reinforcing material of at least 50 percent. The reinforcing material may comprise a fiber material; the fiber material may comprise glass fiber. The crystallization rate may be configured to reduce glass fiber exposure in the composition. The composition of the component may comprise toner. The composition of the component may comprise lubricant. The composition of the component may comprise optional antioxidant. The composition of the component may comprise optional anti-light adjuvant. The composition of the component may comprise optional antioxidant of about 0.3 percent; the composition of the component may comprise optional anti-light adjuvant of about 0.2 percent. The composition may comprise a combined mass fraction of compatible resin and copolymer no greater than 20 percent of the total mass. The compatible resin may comprise amorphous polyamide. The composition of the component may comprise less than about 1 percent polyamide 6 (PA6). The component may be formed as injection-molded piece.

The present invention relates to a method of producing of an injection molded component comprising the steps of providing a polyketone resin which is an aliphatic polyketone; adding the polyketone resin, a compatible resin, a copolymer resin, a compatibilizer and a reinforcing material into an extruder for polyketone modification to provide reinforced polyketone composite particles; the compatible resin may be a resin with good compatibility with the polyketone resin, and the mass ratio of the polyketone resin, the compatible resin, the copolymer resin, the compatilizer and the reinforcing material may be 15-90:1-10:1-10:1-5:5-60; the method may comprise the step of adding the reinforced polyketone composite material particles into a mold for molding to form an injection molded part. The mass ratio of the polyketone resin, the compatible resin, the copolymer resin, the compatibilizer and the reinforcing material may be 25-44:1-10:1-5:1-5:45-55. The compatible resin may be an ester resin or an amide resin. The compatible resin may be an amorphous polyester or an amorphous polyamide. The copolymer resin may be a methyl methacrylate copolymer. The compatibilizer may be a polyolefin grafted glycidyl methacrylate. The reinforcing material may be a powdery mineral or a fiber reinforcing material. The reinforcing material may be surface-treated with a polar coating. The step of modifying the polyketone resin may comprise adding an antioxidant and/or an anti-light adjuvant and/or a lubricant and/or a toner into the extruder. The extruder may be a twin-screw extruder. An injection molded part may be obtained by the method.

### FIGURES

FIG. 1 is a schematic perspective view of a vehicle according to an exemplary embodiment.

FIG. 2A is a schematic partial perspective view a vehicle showing the vehicle interior according to an exemplary embodiment.

FIG. 2B is a schematic partial perspective view a vehicle interior according to an exemplary embodiment.

FIG. 3 is a schematic perspective view of a vehicle interior component shown as an instrument panel according to an exemplary embodiment.

FIG. 4 is a schematic perspective view of a vehicle interior component shown as a door panel according to an exemplary embodiment.

FIGS. 5A and 5B are a schematic perspective views of a vehicle interior component shown as a floor console according to an exemplary embodiment.

FIG. 6A is a schematic perspective view of a vehicle interior component shown as an air vent assembly according to an exemplary embodiment.

FIG. 6B is a schematic perspective view of a component of an air vent assembly according to an exemplary embodiment.

FIG. 7 is a schematic representation of a component with the polymer composition according to an exemplary embodiment.

FIG. 8 is a schematic representation of a component with the polymer composition according to an exemplary embodiment.

FIG. 9 is a schematic representation of a component with the polymer composition according to an exemplary embodiment.

FIG. 10 is a schematic partial representation of the component with the polymer composition according to an exemplary embodiment.

FIG. 11 is a schematic partial representation of a component with a conventional/comparative polymer composition according to an exemplary embodiment.

FIG. 12A is a schematic photographic representation of a component with the polymer composition according to an exemplary embodiment.

FIG. 12B is a schematic partial photographic representation of the component of FIG. 12A.

FIG. 13A is a schematic photographic representation of a component with the polymer composition according to an exemplary embodiment.

FIG. 13B is a schematic partial photographic representation of the component of FIG. 13A.

FIG. 14A is a schematic photographic representation of a component with the polymer composition according to an exemplary embodiment.

FIG. 14B is a schematic partial photographic representation of the component of FIG. 14A.

FIG. 15A is a schematic photographic representation of a component with a conventional/comparative polymer composition according to an exemplary embodiment.

FIG. 15B is a schematic partial photographic representation of the component of FIG. 15A.

FIG. 16 is a graph of crystallinity for Examples 1 to 8 according to an exemplary embodiment.

### TABLES

TABLE 1 is a table of the composition of the component according to an exemplary embodiment.

TABLE 2 is a table of operating conditions for a method of producing the component according to an exemplary embodiment.

TABLE 3A is a table of Examples 1 to 4 of the composition of the component according to an exemplary embodiment.

TABLE 3B is a table of Examples 5 to 8 of the composition of the component according to an exemplary embodiment.

TABLE 4 is a composite table of Examples 1 to 8 of the composition of the component according to an exemplary embodiment.

### DESCRIPTION

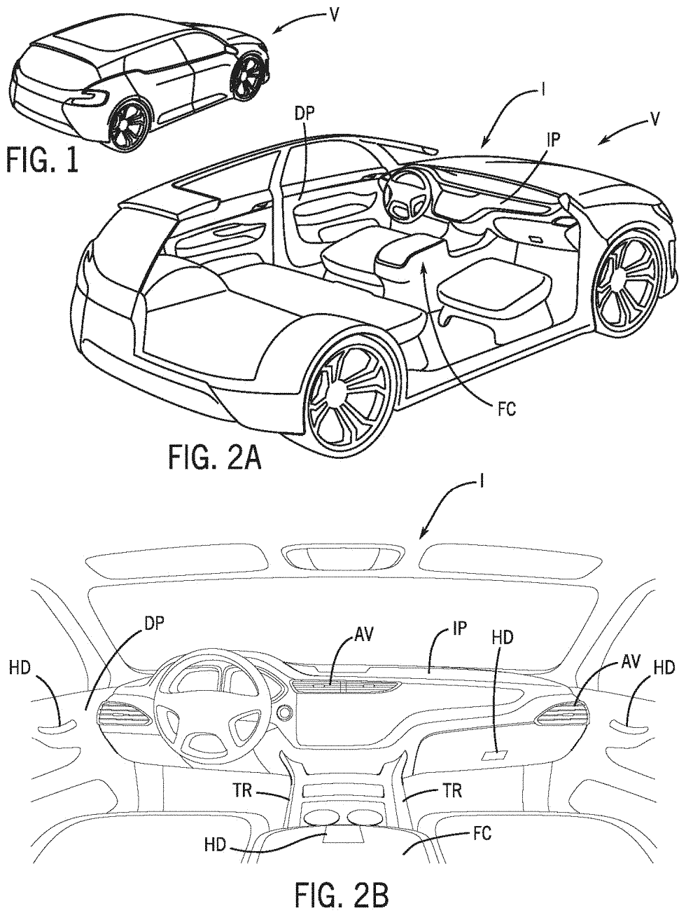

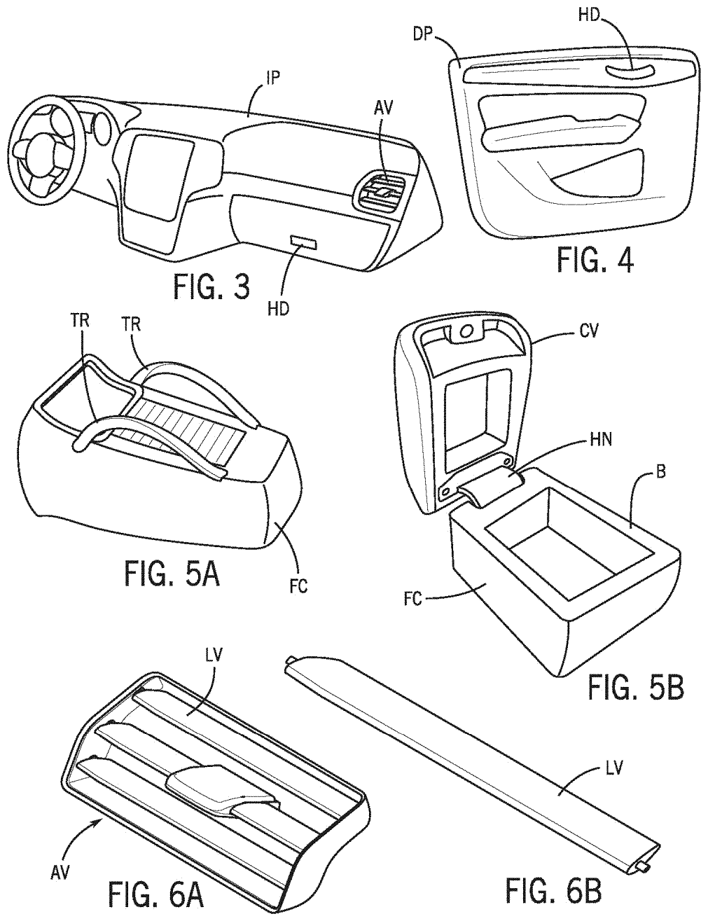

According to an exemplary embodiment as shown schematically in FIGS. 1 and 2A-2B, a vehicle V may comprise a vehicle interior I comprising components shown as instrument panel IP, door panel DP, console shown as floor console FC and other components such as air vent assembly AV. See also FIGS. 3, 4, 5A-5B and 6A. As indicated schematically in FIGS. 2B, 4, 5A-5B and 6A-6B, vehicle interior components may comprise features (e.g. parts, components, elements, etc.) such as operational elements/parts shown as handles HD, functional elements/parts shown as hinge HN, decorative/trim elements shown as trim piece TR and assembly elements/parts such as louver/blade LV (among other parts/components).

As indicated schematically according to an exemplary embodiment in FIGS. 6B, 7, 8, 9, 12A, 13A and 14A, such components may be produced from a polymer composition comprising a range of constituents intended to provide intended physical/performance characteristics including but not limited to an intended visual appearance/effect as indicated schematically in FIGS. 10, 12B, 13B and 14B. See also FIG. 2B and TABLES 1 and 3A. Compare FIGS. 6A, 7 and 12A (louver/blade with button attachment area indicated).

According an exemplary embodiment, the polymer composition for the components may comprise a modified polyketone with a reinforcing material (such as glass fiber, etc.) in a formulation suitable to be used to produce components for a vehicle interior (e.g. by injection molding, etc.); as indicated, the polymer composition may be used to produce components that may otherwise be produced from or with materials (e.g. polymers such as polyamide, etc. and/or metal alloys such as zinc alloy, etc.) and/or the polymer composition may be used in a manner facilitating the replacement of other manufacturing techniques/manufactured parts (e.g. die-cast parts, molded plastic/resin parts, etc.) with manufacturing techniques/parts suited for use of the polymer composition.

According to an exemplary embodiment, the component may comprise a polymer composition configured/formulated with a reinforcing material (that may reduce cost and/or weight, etc.) and that is formed to provide suitable mechanical properties for use/function (e.g. strength, durability, etc.) and to present an acceptable effect/visual appearance (e.g. intended consistency, color/shade, texture, etc.) for the component in the vehicle interior. See e.g. FIGS. 10, 12A-12B, 13A-13B and 14A-14B. According to an exemplary embodiment, the component will not require further surface treatment after forming (e.g. painting, spraying, etc.).

### Exemplary Embodiments—A

According to an exemplary embodiment a method for producing a component with the polymer composition may comprise producing an injection-molded component with a polymer composition comprising a polyketone resin. As indicated, the polyketone resin may comprises an aliphatic polyketone (e.g. of a linear structure and regular in molecular structure and with a polar ketone group) such as formed by polymerizing ethylene and carbon monoxide monomers; a third monomer (such as a propylene monomer) may be added to improve performance such as fluidity, etc.

The method may comprise modifying the polyketone resin to provide reinforced polyketone composite particles; the polyketone resin with a compatible resin, a copolymer resin, a compatibilizer, and a reinforcing material may be combined (e.g. added in an extruder) for polyketone modification; the polyketone resin with the compatible resin, the copolymer resin and the compatibilizer may be combined by melting (e.g. melting into a liquid within the extruder); as indicated, a high molecular weight compatible resin and a medium molecular weight copolymer resin may be uniformly mixed with the polyketone resin with the aid of the compatibilizer (e.g. within the extruder).

According to an exemplary embodiment, the method may comprise producing a formulation of the polymer composition comprising a polyketone resin in which the high molecular weight compatible resin is treated/handled (e.g. passed through physical barriers) to reduce the generation of large-crystal structures within the polyketone resin in the cooling process (e.g. after extrusion); the medium molecular weight copolymer resin may be expected to prevent the generation of small crystal structures within the polyketone resin; the small molecular weight compatibilizer may be expected to enter the molecular structure/chain of the polyketone resin (e.g. molecular chain segment in the small space of the polyketone resin) to prevent the generation of microcrystal structures of the polyketone resin.

According to an exemplary embodiment, the compatible resin, the copolymer resin and the compatibilizer may be expected to combine suitably (e.g. with synergistic effect and well fused/formed) with improved infiltration of the reinforcing material (e.g. glass fiber, etc.) and in a suitable matrix structure of the resin material (e.g. polyketone resin, compatible resin and copolymer resin) to form reinforced polyketone composite/structure (e.g. formed of particles).

According to an exemplary embodiment, the extruder may comprise a twin-screw extruder or any other suitable type of extruder capable of performing the polyketone modification.

According to an exemplary embodiment, the compatible resin may comprise a resin having suitable compatibility with the polyketone resin (e.g. suitable for formulating into the composition as indicated). According to an exemplary embodiment, the compatible resin may comprise an ester resin or an amide resin or an amorphous polyester or an amorphous polyamide.

According to an exemplary embodiment, the copolymer resin may comprise a methyl methacrylate copolymer such as an ethylene/butyl acrylate/glycidyl methacrylate.

According to an exemplary embodiment, the compatibilizer may comprise a GMA grafted polyolefin such as a glycidyl methacrylate grafted poly(ethylene octene) (POE-g-GMA).

According to an exemplary embodiment, the reinforcing material may comprise a modifier such as a filler and/or for reinforcement (e.g. to enable the polyketone resin to function with suitable load-bearing capacity); the reinforcing material may be selected from powdered minerals such as talc powder, mica powder, wollastonite powder and the like, and from fibers such as glass fibers, carbon fibers, aramid fibers, basalt fibers and the like. According to an exemplary embodiment, the reinforcing material such as modifier/filler may comprise a glass fiber material (e.g. glass fibers/material as widely used as reinforcing material for cost reasons, etc.); the reinforcing material may be surface-treated (e.g. with a polar coating to facilitate fusion with the polymer composition resin during the polyketone resin modification process).

According to an exemplary embodiment, the step of modifying the polyketone resin may (optionally) comprise adding an antioxidant material (e.g. into the extruder at mixing); the thermal aging properties of the reinforced polyketone composite material/particles (e.g. injection molded parts/pieces) may be improved by modifying the polyketone resin by adding an antioxidant material; the antioxidant material may comprise a primary antioxidant from the group of secondary aromatic amines or of hindered phenols and auxiliary antioxidants from the group of phosphite or of organic sulfur compounds. (e.g. primary antioxidants 1010/1076 and auxiliary antioxidants 168/618, etc.).

According to an exemplary embodiment, the step of modifying the polyketone resin may (optionally) comprise adding a light stabilizer (e.g. into the extruder at mixing); the stability of the reinforced polyketone composite material/particles (e.g. injection molded parts/pieces) may be improved by adding the light stabilizer (and then storing the parts/pieces under light for a determined/suitable period of time); the light stabilizer may be selected from the group consisting of a light shield, an ultraviolet absorber, an excited state quencher, a hydroperoxide decomposer, and a free radical scavenger.

According to an exemplary embodiment, the step of modifying the polyketone resin may (optionally) comprise adding a lubricant (e.g. into the extruder at mixing); the fluidity and mold-release performance of the reinforced polyketone composite particles may be improved by adding the lubricant; the lubricant may comprise a calcium stearate and/or a zinc stearate.

According to an exemplary embodiment, the step of modifying the polyketone resin may (optionally) comprise adding a toner (e.g. into the extruder at mixing); the color appearance/requirements of the reinforced polyketone composite material/particles (e.g. injection molded parts/pieces) may be enhanced with a toner; the toner may comprise an inorganic type toner such as carbon black, metal oxide, etc.

According to an exemplary embodiment, the components/constituents of a polymer composition (by mass fraction/percent weight) (with range) are indicated in TABLE 1.

TABLE 1
COMPOSITION OF POLYMER MATERIAL
Components/constituents of the Composition
(/percent by weight) (range)

| | |
|---|---|
| Polyketone resin | about 15 to 90 |
| Compatible resin (amorphous polyamide) | about 1 to 10 |
| Copolymer | about 1 to 10 |
| Compatibilizer | about 1 to 5 |
| Reinforcing material (glass fiber) | about 5 to 60 |
| Antioxidant | about 0.1 to 2 |
| Light stabilizer | about 0.1 to 2 |
| Lubricant | about 0.1 to 3 |
| Toner | about 0.1 to 5 |

According to an exemplary embodiment, a method of preparing a part/piece with the polymer composition may further comprise forming the part/piece by reinforcing the polyketone composite material/particles for the component in a molding/injection mold operation. See e.g. FIGS. 3, 4, 5A-5B and 6A-6B.

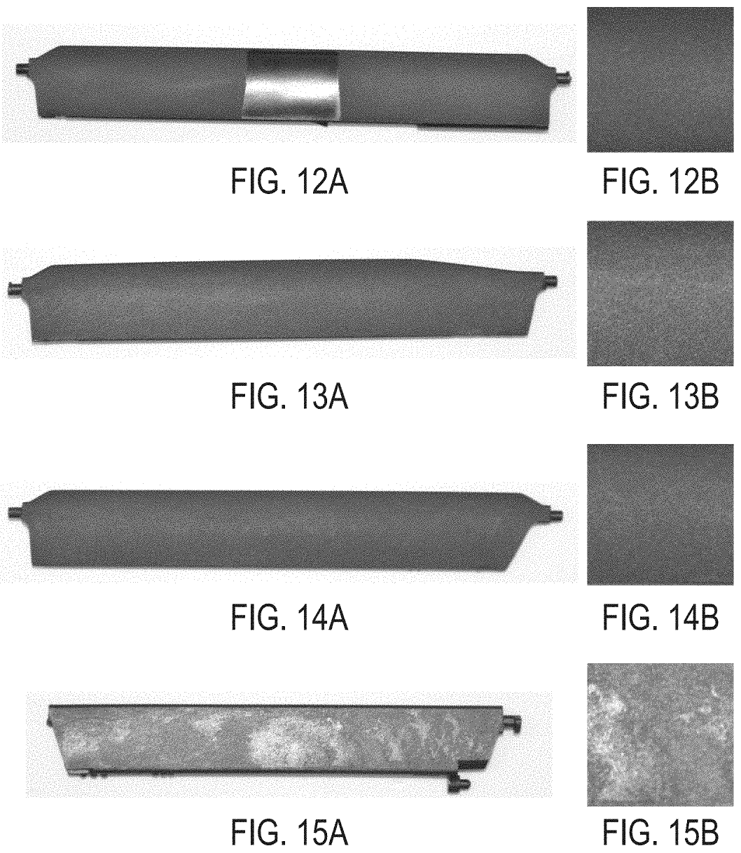

As indicated schematically according to an exemplary embodiment the reinforced polyketone composite material/particles may be added to a tool such an injection mold; in an injection molding process, the reinforced polyketone composite material/particles may be heated and melted (e.g. as in the extrusion/mixing process); the crystallinity of the polyketone resin, the compatible resin and the copolymer resin is expected to be reduced in the injection molding operation; crystallization rate (can be characterized by the reciprocal half-time of crystallization) is expected to become longer; the reinforcing material is expected better to infiltrate and embed into the resin matrix with consistency (e.g. rather than to be fixed at the surface of the mold) and the resin matrix/mixture is expected more completely and consistently to replicate the texture of the surface of the injection mold cavity (e.g. the intended effect/visual appearance). See FIGS. 12A-12B, 13A-13B and 14A-14B (indicating surface of the component providing an acceptable consistency and suitable effect/visual appearance). Compare FIG. 10 (indicating consistent surface effect) with FIGS. 11 and 15A-15B (indicating inconsistent surface effect).

As indicated schematically in FIGS. 10 and 11, the crystallization rate of the polyketone may be reduced due to the addition of the compatible resin; the reinforcing material may be sufficiently infiltrated during cooling in the mold to reduce/eliminate the visible emergence of the reinforcing material (e.g. glass fiber, etc.); the appearance of the injection molded piece formed by the reinforced polyketone composite material/particles may be improved. Compare FIG. 10 (indicating consistent surface effect) with FIGS. 11 and 15A-15B (indicating inconsistent surface effect).

According to an exemplary embodiment, a component for a vehicle interior configured to provide a surface may be formed from a composition comprising by mass fraction in percent polyketone resin in a range of less than about 40 weight percent, compatible resin; copolymer; compatibilizer; reinforcing material.

The component may be formed from the composition to provide a crystallinity above about 15 percent; the component may be formed from the composition to provide a half-time of crystallization above about 42 seconds; an effect on the surface may be provided by the composition as a result of the crystallinity, the crystallization rate and the half-time of crystallization. The component may be formed from the composition to provide a crystallinity in a range of between about 17 to 26 percent. The component may be formed from the composition to provide a half-time of crystallization of between about 42 and 51 seconds.

The effect on the surface may be provided by the crystallinity, crystallization rate and the half-time of crystallization of the composition. The effect may comprise a visual surface effect. The effect may comprise a visual appearance. The visual appearance may comprise a substantially consistent surface effect. The effect may comprise a substantially consistent visual effect at the surface. (The crystallization process may comprise a half-time of crystallization for formation of the composition.) The composition of the component may comprise polyketone resin in a range of less than about 40 weight percent. The composition of the component may comprise compatible resin in a range of less than about 10 weight percent. The composition of the component may comprise polyketone resin in a range of between about 31 to 39 weight percent. The composition of the component may comprise compatible resin in a range of between about 1 to 10 weight percent. The composition of the component may comprise copolymer in a range of less than about 5 weight percent. The composition of the component may comprise compatibilizer in a range of greater than about 1 weight percent. The composition of the component may comprise polyketone resin in a range of between about 31 to 39 weight percent, the composition may comprise compatible resin in a range of between about 1 to 10 weight percent, the composition of the component may comprise copolymer in a range of between about 1 to 5 weight percent, the composition of the component may comprise compatibilizer in a range of between about 2 to 5 weight percent. The composition may be mixed in an extrusion machine. The composition may be formed in a mold. The composition may be formed in a mold configured to be maintained at a temperature in a range of between about 110 to 140 degrees Centigrade. The component may be formed in a mold operated at a temperature in a range of between about 110 to 140 degrees Centigrade. The component may be formed in a mold configured to be maintained at a temperature in a range of between about 125 to 135 degrees Centigrade. The component may be formed in a mold providing a surface effect; the effect at the surface provided by the composition may comprise a visual effect generally resembling the surface effect of the mold. The component may be formed as a molded component. The component may be formed as an injection-molded component. The composition of the component may comprise a polymer material. The composition of the component may comprise a polyketone composite material. The composition of the component may comprise a resin material. The composition of the component may comprise a resin matrix. The composition of the component may comprise a resin matrix and a fiber material. The composition of the component may comprise a fiber-reinforced composite material. The composition of the component may comprise reinforcing material in a range of between about 40 and 60 weight percent. The composition of the component may comprise reinforcing material of at least 50 weight percent. The reinforcing material may comprise a fiber material; the fiber material may comprise glass fiber. The crystallization rate may be configured to reduce glass fiber exposure in the composition. The composition of the component may comprise toner. The composition of the component may comprise lubricant. The composition of the component may comprise optional antioxidant. The composition of the component may comprise optional light stabilizer. The composition of the component may comprise optional antioxidant of about 0.3 weight percent. The composition of the component may comprise optional light stabilizer of about 0.2 weight percent. The composition of the component may comprise a combined mass fraction of compatible resin and copolymer no greater than 20 weight percent of the total mass. The compatible resin may comprise amorphous polyamide. The composition of the component may comprise less than about 1 weight percent polyamide 6 (PA6). The component may be formed as injection-molded piece (e.g. part, component, etc.).

According to an exemplary embodiment, a method of producing of an injection molded component may comprise the steps of providing a polyketone resin which is an aliphatic polyketone; adding the polyketone resin, a compatible resin, a copolymer resin, a compatibilizer and a reinforcing material into an extruder for polyketone modification to provide reinforced polyketone composite particles; the compatible resin may be a resin with good compatibility with the polyketone resin, and the mass ratio of the polyketone resin may be 15 to 90 weight percent, the compatible resin may be 1 to 10 weight percent, the copolymer resin may be 1 to 10 weight percent, the compatibilizer may be 1 to 5 weight percent, and the reinforcing material may be 5 to 60 weight percent, the method may comprise the step of adding the reinforced polyketone composite material particles into a mold for molding to form an injection molded part. The method may be characterized in that the mass ratio of the polyketone resin may be 25 to 44 weight percent, the compatible resin may be 1 to 10 weight percent, the copolymer resin may be 1 to 5 weight percent, the compatibilizer may be 1 to 5 weight percent, and the reinforcing material may be 45 to 55 weight percent. The method may be characterized in that the compatible resin is an ester resin or an amide resin. The method may be characterized in that the compatible resin is an amorphous polyester or an amorphous polyamide. The method may be characterized in that the copolymer resin is a methyl methacrylate copolymer. The method may be characterized in that the compatibilizer is a GMA grafted polyolefin. The method may be characterized in that the reinforcing material is a powdery mineral or a fiber reinforcing material. The method may be characterized in that the reinforcing material is surface-treated with a polar coating. The method may be characterized in that the step of modifying the polyketone resin may comprise adding an antioxidant and/or a light stabilizer and/or a lubricant and/or a toner into the extruder. The method may be characterized in that the extruder comprises a twin-screw extruder (e.g. for the injection molding apparatus); an injection molded part may be produced/obtained by the method.

According to an exemplary embodiment, the method of preparing/producing the component from the polymer material may comprise the combination of the compatible resin, the copolymer resin and the compatibilizer added in a modification process for the polyketone; crystallization of the polyketone in the modification process is disturbed; the crystallinity of the polyketone is reduced, the crystallization rate is slowed; the reinforcing material is sufficiently infiltrated in the cooling process of the mold; the reinforcing material emergence is reduced at the surface of an injection molded part/component to improve the visual appearance of the injection molded piece/part made of the reinforced polyketone composite material/particles. According to an exemplary embodiment, the method may be used to prepare injection molded pieces/parts to satisfy stringent appearance requirements (e.g. including by effectively preventing/reducing the reinforcing material emergence on the surface of the component).

### Operating Conditions

According to an exemplary embodiment as indicated in TABLE 2, operating conditions to produce a component using the formulation and method comprise mold temperature for the injection mold/tool surfaces (e.g. preferred range 110-140 degrees Centigrade (deg C.) and optimal range 125-135 deg C.); mold temperature in injection molding is observed as a factor to control the surface quality of the molded parts. See FIGS. 12A-12B, 13A-13B and 14A-14B.

As indicated schematically, selection and control of operating conditions for the injection molding operation may facilitate performance improvement; test and comparative examples (under the operating conditions of time, temperature, etc.) were completed to determine suitable performance/ranges for the formulation of the polymer composition to produce components.

According to an exemplary embodiment it was intended to provide an improved polymer composite (for formation/production of an improved vehicle interior component) in a formulation to present suitable mechanical properties and an acceptable effect/visual appearance at the surface without requiring treatment which may be achieved by a range of desired/qualified values of crystallinity and crystallization rate (characterized by the reciprocal half-time of crystallization) of the polymer composition correlated to the acceptable effect/visual appearance.

### EXAMPLES

As indicated according to an exemplary embodiment in TABLE 3A, Examples 1-4 were considered to represent a composition (e.g. compositional range of polyketone resin, compatible resin, copolymer, compatibilizer, reinforcing material/glass fiber with other constituents) to producing a crystallinity and crystallization rate believed to provide a suitable visual appearance (e.g. acceptable and preferred). See FIGS. 10, 12A-12B, 13A-13B and 14A-14B.

TABLE 3A
EXAMPLES
Components/constituents of the Example Composition
(percent by weight)
(Visible Appearance-Acceptable/Preferred) (see FIGS.
10, 12A-12B, 13A-13B and 14A-14B)

| Example | 1 | 2 | 3 | 4 |
|---|---|---|---|---|
| Polyketone resin | 39 | 39 | 31 | 36 |
| Compatible resin | 5 | 1 | 10 | 5 |
| (amorphous polyamide) | | | | |
| Polyamide 6 (PA6) | — | — | — | — |
| Copolymer | 1 | 3 | 5 | 5 |
| Compatibilizer | 3 | 5 | 2 | 2 |
| Reinforcing material (glass fiber) | 50 | 50 | 50 | 50 |
| Antioxidant | 0.3 | 0.3 | 0.3 | 0.3 |
| Light stabilizer | 0.2 | 0.2 | 0.2 | 0.2 |
| Lubricant | 0.5 | 0.5 | 0.5 | 0.5 |
| Toner | 1 | 1 | 1 | 1 |
| Crystallinity of modified material | 24 | 26 | 17 | 20 |
| (percent) | | | | |
| (isothermal 185 deg Centigrade) | | | | |
| Half-time of crystallization | 43 | 42 | 51 | 47 |
| (seconds) | | | | |
| (isothermal 185 deg Centigrade) | | | | |
| Visible Appearance of Part | A | A | P | P |
| A-acceptable | | | | |
| N-not preferred | | | | |
| P-preferred | | | | |

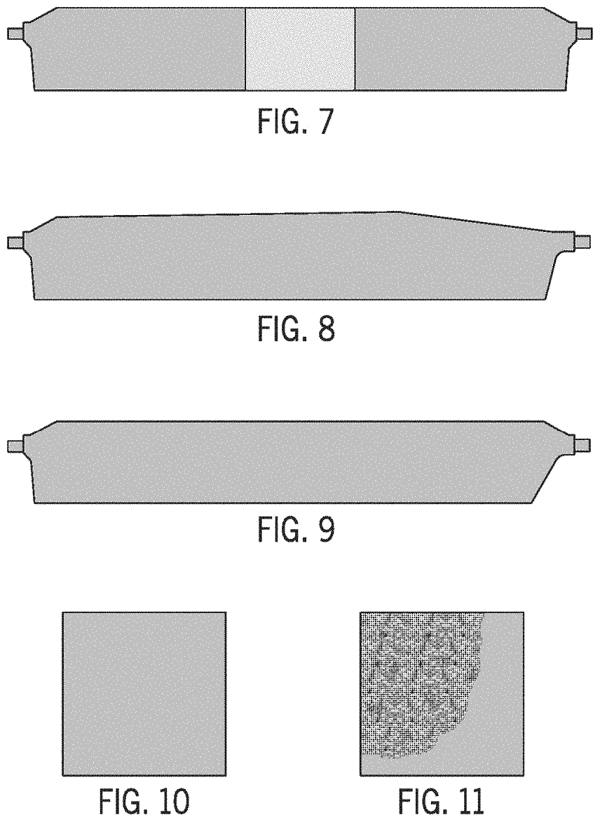

As indicated in TABLE 3A according to an exemplary embodiment, application of the method and composition for Example 1 through 4 resulted in production of example components determined to provide an acceptable visual appearance. See for example FIGS. 7, 8, 9, 10, 12A-12B, 13A-13B and 14A-14B. According to an exemplary embodiment it was ascertained that under the operating conditions the selected examples (Examples 1-4) produced a crystallinity in a range of between 17 and 26 percent with a half-time of crystallization in a range of between 42 and 51 seconds. See also TABLE 2.

### Example 1

In the example, the mass of copolymer is reduced and the mass of compatibilizer is increased; crystallinity, crystallization rate and half-time of crystallization are suitable to provide acceptable visual appearance (as intended).

### Example 2

In the example, the total mass of copolymer and compatibilizer is reduced; crystallinity, crystallization rate and half-time of crystallization are suitable to provide acceptable visual appearance (e.g. within qualified/critical value).

### Example 3

In the example, with added compatible resin and copolymer and compatibilizer, the total mass of compatible resin and copolymer is largest; crystallinity is reduced, crystallization rate is reduced and half-time of crystallization is increased to provide acceptable visual appearance (e.g. not optimum but within qualified/critical value).

### Example 4

In the example, the mass of compatible resin is reduced; crystallinity, crystallization rate and half-time of crystallization are suitable/improved to provide acceptable/improved visual appearance (e.g. within qualified/critical value).

### COMPARATIVE (OTHER) EXAMPLES

As indicated according to an exemplary embodiment in TABLE 3B, the Comparable Examples 1-4 were considered to represent a composition (e.g. compositional range of polyketone resin, compatible resin, polyamide, copolymer, compatibilizer, reinforcing material/glass fiber with other constituents) to producing a crystallinity, crystallization rate and half-time of crystallization believed to provide a varying visual appearance (not preferred and acceptable). See FIGS. 11 and 15A-15B.

TABLE 3B
COMPARABLE EXAMPLES
Components/constituents of the Example Composition
(by mass fraction/weight percent/percent by weight)
(Visible Appearance-Not Preferred/Acceptable)
(see FIGS. 11 and 15A-15B)

| Comparable Example | 1 (5) | 2 (6) | 3 (7) | 4 (8) |
|---|---|---|---|---|
| Polyketone resin | 48 | 39 | 31 | 38 |
| Compatible resin | — | 5 | — | 5 |
| (amorphous polyamide) | | | | |
| Polyamide 6 (PA6) | — | 5 | 5 | — |
| Copolymer | — | — | 5 | 5 |
| Compatibilizer | — | 2 | 2 | — |
| Reinforcing material (glass fiber) | 50 | 50 | 50 | 50 |
| Antioxidant | 0.3 | 0.3 | 0.3 | 0.3 |
| Light stabilizer | 0.2 | 0.2 | 0.2 | 0.2 |
| Lubricant | 0.5 | 0.5 | 0.5 | 0.5 |
| Toner | 1 | 1 | 1 | 1 |
| Crystallinity of modified material | 31 | 27 | 28 | 25 |
| (percent) | | | | |
| (isothermal 185 deg Centigrade) | | | | |
| Half-time of crystallization | 36 | 39 | 39 | 41 |
| (seconds) | | | | |
| (isothermal 185 deg Centigrade) | | | | |
| Visible Appearance of Part | N | N | N | A |
| A-acceptable | | | | |
| N-not preferred | | | | |
| P-preferred | | | | |

As indicated in TABLE 3B according to an exemplary embodiment, application of the method and composition for Comparable Examples 1 through 4 resulted in production of example components determined to provide a not-preferred visual appearance. See for example FIGS. 11 and 15A-15B. According to an exemplary embodiment it was ascertained that under the operating conditions the selected examples (Comparable Examples 1-4) produced a crystallinity in a range of greater than 24 percent with a crystallinity rate (characterized by the half-time of crystallization) in a range of less than 42 seconds. See also TABLE 2.

### Comparative Example 1 (Example 5)

In the example, a conventional formulation is used that does not comprise compatible resin, copolymer, polyamide (PA6) or compatibilizer; crystallinity is beyond an accepted/qualified range (e.g. due to high crystallinity of polyketone resin constituent); example indicates to reduce crystallinity by reducing the mass of polyketone resin by adding compatible resin and copolymer to provide an acceptable rather than not-preferred visual appearance.

### Comparative Example 2 (Example 6)

In the example, replacement of copolymer with polyamide (PA6) as a potential cost-saving measure; crystallinity, crystallization rate and half-time of crystallization are non-ideal to provide intended/acceptable visual appearance.

### Comparative Example 3 (Example 7)

In the example, replacement of compatible resin with polyamide (PA6); crystallinity, crystallization rate and half-time of crystallization are non-ideal to provide intended/acceptable visual appearance.

### Comparative Example 4 (Example 8)

In the example, without added polyamide (PA6) and with removal of compatibilizer; crystallinity is acceptable but the generation of microcrystal structures of the polyketone resin is reduced and the crystallization is beyond acceptable/qualified range to provide acceptable visual appearance; example indicates that compatibilizer provides a beneficial effect (e.g. may be necessary for formulation).

As indicated in TABLES 3A and 3B, it appears that both crystallinity (within qualified scope) and crystallinity rate (characterized by the reciprocal half-time of crystallization) (within qualified scope) will correlate to an intended/desired visible appearance. Crystallinity rate (e.g. outside of the qualified range/scope of half-time of crystallization of 42-51 seconds) will produce a component that if too low will present a visual appearance not-preferred and that if too high will provide unsuitable mechanical properties (such as inadequate tensile strength and bending modulus). Crystallinity (e.g. outside of the qualified scope of 17-26 percent) will produce a component that if too high will present a visual appearance not preferred and that if too low will provide unsuitable mechanical properties (such as inadequate tensile strength and bending modulus).

According to an exemplary embodiment, the attributes of the formulation of the polymer composition for the component are intended to produce an acceptable appearance and suitable mechanical performance/properties; the reinforcing material or antioxidant or light stabilizer or lubricant or toner provided an auxiliary role; for example, the light stabilizer functions as anti-ultraviolet and anti-photo-aging protection. To reduce the crystallization rate and increase the half-time of crystallization may reduce glass fiber exposure through the component and the not-preferred effect shown schematically in FIGS. 11 and 15A-15B. As indicated, a conventional glass fiber reinforced polyketone without any other resin provides a crystallinity of 31 percent with half-time of crystallization of 36 seconds and non-preferred appearance (e.g. glass fiber emergence indicated in FIG. 11). See Comparable Example 1 in TABLE 3B and FIGS. 11 and 15A-15B. As indicated in TABLE 3A, Examples 1 to 4 comprise suitable performance to provide an acceptable appearance at different mass fractions of compatible resin and copolymer; crystallinity had different percent of reduction; crystallization rate was prolonged (e.g. conducive to resin with glass fiber and beneficial to reduce the glass fiber exposure). According to an exemplary embodiment as indicated, crystallinity is related to the mechanical properties of the component formed from the polymer composition; crystallinity should not be too low (e.g. should be no less than 15 percent); the total mass fraction of compatible resin and copolymer should not exceed 20 weight percent, the compatible resin may be 5 to 8 weight percent and the copolymer may be 3 to 5 weight percent in the formulation of the modified polyketone resin material composition (e.g. polymer material).

According to an exemplary embodiment, a component for a vehicle interior configured to provide a surface and formed from a polymer composition may be provided. The composition may comprise (by mass fraction in percent by weight) polyketone resin in a range of less than about 40 weight percent, compatible resin; copolymer; compatibilizer; reinforcing material. An improved polymer composite (for formation/production of an improved vehicle interior component) may be provided in a formulation to present suitable mechanical properties and an acceptable effect/visual appearance at the surface (without requiring treatment) achieved by a range of desired/qualified values of crystallinity and crystallization rate (characterized by the reciprocal half-time of crystallization) of the polymer composition correlated to the acceptable effect/visual appearance. The composition may be formed to provide a crystallinity above about 15 percent; the composition may be formed to provide a half-time of crystallization above about 42 seconds; an intended/desired effect on the surface may be provided by the composition as a result of the crystallinity (in a range of between about 15 and 26 percent) and the half-time of crystallization in a range of between about 42 and 51 seconds). A method of forming the component is also disclosed.

### COMPOSITE/SUMMARY OF OBSERVATIONS

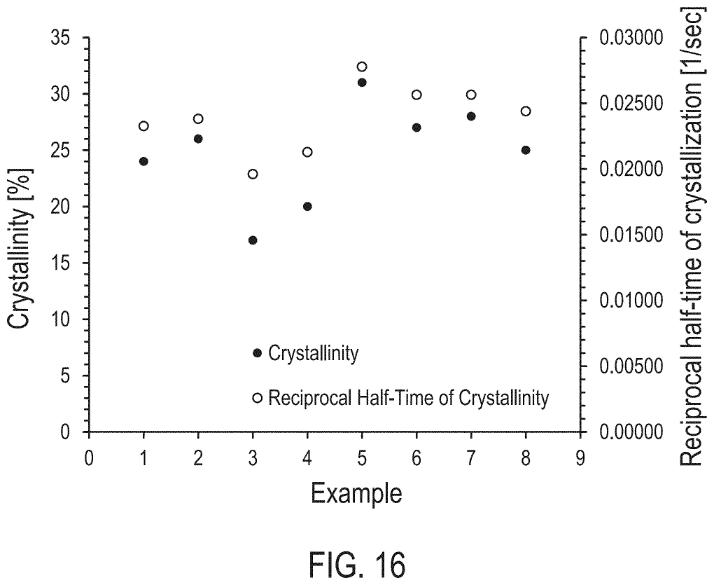

As indicated according to an exemplary embodiment in TABLES 3A-3B and 4, the Examples 1 to 8 were considered to represent a composition (e.g. compositional range of polyketone resin, compatible resin, polyamide, copolymer, compatibilizer, reinforcing material/glass fiber with other constituents) to producing a crystallinity, crystallization rate and half-time of crystallization believed to provide a varying visual appearance (acceptable and preferred and not preferred); crystallinity for the compositions of each of Examples 1 to 8 is shown in a graph provided as FIG. 16. Crystallinity may be determined in an isothermal measurement at 185 degrees Centigrade. As indicated, it has been observed that the composition may be prepared without polyamide, that the compatibilizer for the composition may be glycidyl methacrylate (GMA)-grafted (rather than maleic anhydride (MAH)-grafted), that polyketone without treatment may result in higher crystallinity, and that improved integration of glass fiber (reinforcing material) in the composition may be achieved with acceptable results for visual appearance. See TABLES 3A-3B and 4. As indicated, the component made from the composition has been observed to provide suitable performance/mechanical properties for use in a vehicle interior. See FIGS. 3, 4, 5A-5B and 6A-6B. The process for producing the component from the composition could include mixing of the constituents/ingredients (e.g. polyketone, compatible resin, compatibilizer, copolymer, glass fiber, etc.) in an extruder (e.g. two-screw extruder) to produce granules that then can be provided to the screw extruder/feeder of the injection molding apparatus/machine (e.g. mold); a mold temperature in the range of 100 to 140 degrees Centigrade) may help to reduce the cooling rate of the component in the mold and to reduce the crystallization rate (i.e. allowing more time for the resin to infiltrate the fiber surface); a compatible resin (e.g. less than 1 percent of amorphous polyamide) was observed to be useful to reduce glass fiber exposure on the surface of the component; the component could be observed to provide an acceptable surface appearance (e.g. reduced/no glass fiber readily visible at the surface) with low crystallinity (e.g. acceptable surface treatment/sizing and quality).

TABLE 4
COMPOSITE OF EXAMPLES
Components/constituents of the Example Composition
(percent by weight)

| Example | 1 | 2 | 3 | 4 | 5 | 6 | 7 | 8 |
|---|---|---|---|---|---|---|---|---|
| Polyketone resin | 39 | 39 | 31 | 36 | 48 | 39 | 31 | 38 |
| Compatible resin | 5 | 1 | 10 | 5 | — | 5 | — | 5 |
| (amorphous | | | | | | | | |
| polyamide) | | | | | | | | |
| Polyamide 6 | — | — | — | — | — | 5 | 5 | — |
| (PA6) | | | | | | | | |
| Copolymer | 1 | 3 | 5 | 5 | — | — | 5 | 5 |
| Compatibilizer | 3 | 5 | 2 | 2 | — | 2 | 2 | — |
| Reinforcing | 50 | 50 | 50 | 50 | 50 | 50 | 50 | 50 |
| material (glass | | | | | | | | |
| fiber) | | | | | | | | |
| Antioxidant | 0.3 | 0.3 | 0.3 | 0.3 | 0.3 | 0.3 | 0.3 | 0.3 |
| Light stabilizer | 0.2 | 0.2 | 0.2 | 0.2 | 0.2 | 0.2 | 0.2 | 0.2 |
| Lubricant | 0.5 | 0.5 | 0.5 | 0.5 | 0.5 | 0.5 | 0.5 | 0.5 |
| Toner | 1 | 1 | 1 | 1 | 1 | 1 | 1 | 1 |
| Crystallinity of | 24 | 26 | 17 | 20 | 31 | 27 | 28 | 25 |
| modified | | | | | | | | |
| material | | | | | | | | |
| (percent) | | | | | | | | |
| (isothermal 185 | | | | | | | | |
| deg Centigrade) | | | | | | | | |
| Reciprocal Half- | 2.3E−02 | 2.4E−02 | 2.0E−02 | 2.1E−02 | 2.8E−02 | 2.6E−02 | 2.6E−02 | 2.4E−02 |
| time of | 0.02326 | 0.02381 | 0.01961 | 0.02128 | 0.02778 | 0.02564 | 0.02564 | 0.02439 |
| crystallization | | | | | | | | |
| (1/seconds) | | | | | | | | |
| (isothermal 185 | | | | | | | | |
| deg Centigrade) | | | | | | | | |
| Half-time of | 43 | 42 | 51 | 47 | 36 | 39 | 39 | 41 |
| crystallization | | | | | | | | |
| (seconds) / | | | | | | | | |
| (isothermal 185 | | | | | | | | |
| deg Centigrade) | | | | | | | | |
| Visible | A | A | P | P | N | N | N | A |
| Appearance of | | | | | | | | |
| Part | | | | | | | | |
| A - acceptable | | | | | | | | |
| N - not preferred | | | | | | | | |
| P - preferred | | | | | | | | |

### Exemplary Embodiments—B

According to an exemplary embodiment, a component may be produced from a polymer composition comprising a range of constituents intended to provide intended physical/performance characteristics including but not limited to an intended visual appearance/effect as indicated schematically in FIGS. 10, 12B, 13B and 14B. According to an exemplary embodiment, a method for producing a component with the polymer composition may comprise producing an injection-molded component with a polymer composition comprising a polyketone resin.

According to an exemplary embodiment, an effect on the surface of the component is provided by the composition as a result of the crystallinity, the crystallization rate and the half-time of crystallization. The effect on the surface may be provided by the crystallinity and the crystallization rate of the composition. The effect may comprise a visual surface effect. The effect may comprise a visual appearance. The visual appearance may comprise a substantially consistent surface effect. The effect may comprise a substantially consistent visual effect at the surface. The isothermal crystallization rate can be described by the half-time of the crystallization process, which is defined as the time consumed to reach half of the final crystallinity. Such time increases as the crystallization temperature increases, which is due to diffusion-controlled crystallization (e.g. measured under isothermal conditions at 185 degrees Centigrade). As indicated schematically according to an exemplary embodiment, a relatively large crystallinity and relatively fast crystallization rate of the polyketone material may improve the mechanical properties and shorten the processing period of the material and of the part/component derived from these materials but may cause the surface (of the parts) to form/solidify (e.g. fix, etc.) more quickly; and consequently reinforcing materials such as glass fibers are more likely to be visible at the surface layer (e.g. visible fiber emergence, which adversely affects the appearance of the injection molded piece and that may require treatment of the surface such as by painting, spraying, etc.).

As indicated schematically according to an exemplary embodiment, a component for a vehicle interior may be formed from a composition comprising polyketone resin in a range of less than about 40 percent by weight, compatible resin, copolymer, compatibilizer and reinforcing material. The composition may provide a crystallinity above about 15 percent and a half-time crystallization above about 42 seconds so that an effect on the surface is provided by the composition as a result of the crystallinity and the half-time of crystallization. The component may provide crystallinity in a range of between about 17 to 26 percent. The component may provide half-time of crystallization of between about 42 and 51 seconds. The effect on a surface of the component may be provided by crystallinity and a crystallization rate of the composition; the effect may comprise a substantially consistent visual effect at the surface. The crystallization rate may be characterized by the reciprocal half-time of crystallization for formation of the composition. The composition may comprise polyketone resin in a range between about 25 to 40 percent by weight. The composition may comprise compatible resin in a range of less than about 10 percent by weight. The composition may comprise polyketone resin in a range of between about 31 to 39 percent by weight. The composition may comprise compatible resin in a range of between about 1 to 10 percent by weight. The composition of the component may comprise copolymer in a range of less than about 5 percent by weight. The composition of the component may comprise compatibilizer in a range of greater than about 1 percent by weight. The composition may comprise polyketone resin in a range of between about 31 to 39 percent by weight, compatible resin in a range of between about 1 to 10 percent by weight, copolymer in a range of between about 1 to 5 percent by weight, compatibilizer in a range of between about 2 to 5 percent by weight. The composition may comprise reinforcing material in a range of between about 40 and 60 percent by weight. The composition may comprise less than about 1 percent by weight polyamide 6 (PA6). The composition may comprise a polyketone composite material.

As indicated schematically according to an exemplary embodiment, a method of producing of an injection-molded component providing a surface from a composition in a mold may comprise the steps of providing a polyketone resin comprising an aliphatic polyketone, adding the polyketone resin, a compatible resin, a copolymer resin, a compatibilizer and a reinforcing material into an extruder for polyketone modification to provide a reinforced polyketone composite material for the composition, adding the reinforced polyketone composite material into the mold and forming the injection-molded component from the composition in the mold. The compatible resin may be a resin providing compatibility with the polyketone resin. Mass ratio of the polyketone resin may be about 15 to 90 percent by weight, mass ratio of the compatible resin may be about 1 to 10 percent weight, mass ratio of the copolymer resin may be about 1 to 10 percent by weight, mass ratio of the compatibilizer may be about 1 to 5 percent by weight and mass ratio of the reinforcing material may be about 5 to 60 percent by weight so that an effect on the surface of the injection-molded component is provided by the composition as a result of crystallinity and crystallization rate. Crystallization rate may be characterized by reciprocal of half-time of crystallization. Mass ratio of the polyketone resin may be about 25 to 44 percent by weight and mass ratio of the compatible resin may be about 1 to 10 percent by weight and mass ratio of the copolymer resin may be about 1 to 5 percent by weight and mass ratio of the compatibilizer may be about 1 to 5 percent and mass ratio of the reinforcing material may be about 45 to 55 percent by weight. The composition may comprise glass fiber; crystallization rate may be selected to reduce glass fiber exposure in the composition. The compatibilizer may comprise a polyolefin grafted glycidyl methacrylate. Crystallinity may be determined in an isothermal measurement at 185 degrees Centigrade.

As indicated schematically according to an exemplary embodiment, a component for a vehicle interior configured to provide a surface may be formed from a composition comprising by mass fraction in percent by weight: polyketone resin in a range of less than about 40 percent by weight, compatible resin, copolymer, compatibilizer and reinforcing material. The component may be formed from the composition to provide a crystallinity above about 15 percent and to provide a half-time crystallization above about 42 seconds so that an effect on the surface is provided by the composition as a result of the crystallinity, the crystallization rate and the half-time of crystallization. Crystallinity may be determined in an isothermal measurement at 185 degrees Centigrade. The component may provide a crystallinity in a range of between about 17 to 26 percent. The component may provide a half-time of crystallization of between about 42 and 51 seconds. The effect on the surface may be provided by the crystallinity and the crystallization rate of the composition. The effect may comprise a visual surface effect. The effect may comprise a visual appearance. The visual appearance may comprise a substantially consistent surface effect. The effect may comprise a substantially consistent visual effect at the surface. The crystallization rate may be characterized by the reciprocal half-time of crystallization for formation of the composition. The composition may comprise polyketone resin in a range of less than about 40 percent by weight. The composition may comprise compatible resin in a range of less than about 10 percent by weight. The composition may comprise polyketone resin in a range of between about 31 to 39 percent by weight. The composition may comprise compatible resin in a range of between about 1 to 10 percent by weight. The composition of the component may comprise copolymer in a range of less than about 5 percent by weight. The composition of the component may comprise compatibilizer in a range of greater than about 1 percent by weight. The composition may comprise polyketone resin in a range of between about 31 to 39 percent by weight. The composition may comprise compatible resin in a range of between about 1 to 10 percent by weight. The composition of the component may comprise copolymer in a range of between about 1 to 5 percent by weight. The composition of the component may comprise compatibilizer in a range of between about 2 to 5 percent by weight. The composition may be mixed in an extrusion machine. The composition may be formed in a mold. The composition may be formed in a mold configured to be maintained at a temperature in a range of between about 110 to 140 degrees Centigrade. The component may be formed in a mold operated at a temperature in a range of between about 110 to 140 degrees Centigrade. The component may be formed in a mold configured to be maintained at a temperature in a range of between about 125 to 135 degrees Centigrade. The component may be formed in a mold providing a surface effect; the effect at the surface provided by the composition may comprise a visual effect generally resembling the surface effect of the mold. The component may be formed as a molded component. The component may be formed as an injection-molded component. The composition may comprise a polymer material. The composition may comprise a polyketone composite material. The composition may comprise a resin material. The composition may comprise a resin matrix. The composition may comprise a resin matrix and a fiber material. The composition may comprise a fiber-reinforced composite material. The composition may comprise reinforcing material in a range of between about 40 and 60 percent by weight. The composition may comprise reinforcing material of at least 50 percent by weight. The reinforcing material may comprise a fiber material. The fiber material may comprise glass fiber. The crystallization rate may be configured to reduce glass fiber exposure in the composition. The composition may comprise toner. The composition may comprise lubricant. The composition may comprise optional antioxidant. The composition may comprise optional light stabilizer. The composition may comprise optional antioxidant of about 0.3 percent by weight. The composition may comprise a combined mass fraction of compatible resin and copolymer no greater than 20 percent of total mass by weight. The compatible resin may comprise amorphous polyamide. The composition may comprise less than about 1 percent by weight polyamide 6 (PA6). The component may be formed as an injection-molded piece.

As indicated schematically according to an exemplary embodiment, a method of producing of an injection molded component may comprise the steps of providing a polyketone resin which is an aliphatic polyketone and adding the polyketone resin, a compatible resin, a copolymer resin, a compatibilizer and a reinforcing material into an extruder for polyketone modification to provide reinforced polyketone composite particles. The compatible resin may be a resin with good compatibility with the polyketone resin. Mass ratio of the polyketone resin may be about 15 to 90 percent weight; mass ratio of the compatible resin may be about 1 to 10 percent weight; mass ratio of the copolymer resin may be about 1 to 10 percent weight; mass ratio of the compatibilizer may be about 1 to 5 percent weight; mass ratio of the reinforcing material may be about 5 to 60 percent weight. The method may comprise adding the reinforced polyketone composite material particles into a mold for molding to form an injection molded part. Mass ratio of the polyketone resin may be about 25 to 44 percent by weight and mass ratio of the compatible resin may be about 1 to 10 percent by weight and mass ratio of the copolymer resin may be about 1 to 5 percent by weight and mass ratio of the compatibilizer may be about 1 to 5 percent and mass ratio of the reinforcing material may be about 45 to 55 percent by weight. The compatible resin may be an ester resin or an amide resin. The compatible resin may be an amorphous polyester or an amorphous polyamide. The copolymer resin may be a methyl methacrylate copolymer. The compatibilizer may be a polyolefin grafted glycidyl methacrylate. The reinforcing material may be a powdery mineral or a fiber reinforcing material. The reinforcing material may be surface-treated with a polar coating. The method may comprise the step of modifying the polyketone resin by adding an antioxidant and/or a light stabilizer and/or a lubricant and/or a toner into the extruder. The extruder may comprise a twin-screw extruder.

As indicated schematically according to an exemplary embodiment, a preparation method of an injection molded piece may comprise the steps of providing a polyketone resin comprising an aliphatic polyketone and adding the polyketone resin, a compatible resin, a copolymer resin, a compatibilizer and a reinforcing material into an extruder for polyketone modification to provide reinforced polyketone composite particles. The compatible resin may be a resin with good compatibility with the polyketone resin. The copolymer resin may be a methyl methacrylate copolymer. The mass ratio of the polyketone resin may be about 31 to 39 percent by weight. The mass ratio of the compatible resin may be about 1 to 10 percent by weight. The mass ratio of the copolymer resin may be about 1 to 10 percent by weight. The mass ratio of the compatibilizer may be about 1 to 5 percent by weight. The mass ratio of the reinforcing material may be about 2 to 50 percent by weight. The compatible resin may have a first molecular weight; the copolymer resin may have a second molecular weight; the compatilizer may have a third molecular weight; the first molecular weight may be greater than the second molecular weight; the second molecular weight may be greater than the third molecular weight. The compatible resin may pass through physical barriers to reduce the generation of large crystals of the polyketone resin. The copolymer resin may prevent generation of small crystals of the polyketone resin. The compatibilizer may enter the polyketone molecular chain segment of the small space of the polyketone resin to prevent the generation of microcrystals of the polyketone resin. The method may comprise adding reinforced polyketone composite material particles into a mold for molding to form an injection molded piece. The compatible resin may be an ester resin or an amide resin. The compatible resin may be an amorphous polyester or an amorphous polyamide. The compatibilizer may be a polyolefin grafted glycidyl methacrylate. The reinforcing material may be a powdery mineral or a fiber reinforcing material. The reinforcing material may be surface-treated with a polar coating. The step of modifying the polyketone resin may comprise adding an antioxidant and/or an anti-light adjuvant and/or a lubricant and/or a toner into the extruder. The extruder may be a twin-screw extruder.

As indicated schematically according to an exemplary embodiment, a method of producing of an injection molded component may comprise the steps of providing a polyketone resin which is an aliphatic polyketone; adding the polyketone resin, a compatible resin, a copolymer resin, a compatibilizer and a reinforcing material into an extruder for polyketone modification to provide reinforced polyketone composite particles; the compatible resin may be a resin with good compatibility with the polyketone resin, and the mass ratio of the polyketone resin may be 15 weight percent to 90 weight percent, the compatible resin may be 1 weight percent to 10 weight percent, the copolymer resin may be 1 weight percent to 10 weight percent, the compatilizer may be 1 weight percent to 5 weight percent, and the reinforcing material may be 5 weight percent to 60 weight percent, the method may comprise the step of adding the reinforced polyketone composite material particles into a mold for molding to form an injection molded part. The mass ratio of the polyketone resin may be 25 weight percent to 44 weight percent, the compatible resin may be 1 weight percent to 10 weight percent, the copolymer resin may be 1 weight percent to 5 weight percent, the compatilizer may be 1 weight percent to 5 weight percent, and the reinforcing material may be 45 weight percent to 55 weight percent. The compatible resin may be an amorphous polyester or an amorphous polyamide. The copolymer resin may be a methyl methacrylate copolymer. The compatibilizer may be a glycidyl methacrylate grafted polyolefin (GMA grafted polyolefin). The reinforcing material may be a powdery mineral or a fiber reinforcing material. The reinforcing material may be surface-treated with a polar coating. The step of modifying the polyketone resin may comprise adding an antioxidant and/or a light stabilizer and/or a lubricant and/or a toner into the extruder. The extruder may be a twin-screw extruder. An injection molded part may be obtained by the processing the material in an injection molding machine.

According to an exemplary embodiment. a component for a vehicle interior may be formed from a composition. The component may be produced from a polymer composition comprising a range of constituents intended to provide intended physical/performance characteristics including but not limited to an intended visual appearance/effect as indicated schematically in FIGS. 10, 12B, 13B and 14B. The composition may comprise polyketone resin in a range of less than about 40 percent by weight, compatible resin, copolymer, compatibilizer and reinforcing material. An effect on a surface of the component may be provided by the composition as a result of crystallinity and half-time of crystallization. The composition may provide crystallinity above about 15 percent and half-time crystallization above about 42 seconds. The component may provide crystallinity in a range of between about 17 to 26 percent. The effect provided by crystallinity and crystallization rate of the composition may comprise a substantially consistent visual effect at the surface of the component. The composition may comprise a polyketone composite material. A method of forming the component may provide the crystallinity for the visual surface effect from the composition; the component may be formed in a tool as a molded part.

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

What is claimed is:

1. A component for a vehicle interior configured to provide a surface and formed from a composition comprising:
polyketone resin in a range of less than about 40 percent by weight;
compatible resin;
copolymer;
compatibilizer; and
reinforcing material;
wherein the composition provides a crystallinity above about 15 percent;
wherein the composition provides a half-time of crystallization above about 42 seconds;
so that an effect on the surface is provided by the composition as a result of the crystallinity and the half-time of crystallization.

2. The component of claim 1 formed from the composition to provide crystallinity in a range of between about 17 to 26 percent.

3. The component of claim 1 formed from the composition to provide half-time of crystallization of between about 42 and 51 seconds.

4. The component of claim 1 wherein the effect on the surface is provided by crystallinity and a crystallization rate of the composition; wherein the effect comprises a substantially consistent visual effect at the surface.

5. The component of claim 4 wherein the crystallization rate is characterized by the reciprocal half-time of crystallization for formation of the composition.

6. The component of claim 1 wherein the composition comprises polyketone resin in a range of between about 25 to 40 percent by weight.

7. The component of claim 1 wherein the composition comprises polyketone resin in a range of between about 31 to 39 percent by weight.

8. The component of claim 1 wherein the composition comprises compatible resin in a range of between about 1 to 10 percent by weight.

9. The component of claim 1 wherein the composition of the component comprises copolymer in a range of less than about 5 percent by weight.

10. The component of claim 1 wherein the composition of the component comprises compatibilizer in a range of greater than about 1 percent by weight.

11. The component of claim 1 wherein the composition comprises polyketone resin in a range of between about 31 to 39 percent by weight, compatible resin in a range of between about 1 to 10 percent by weight, copolymer in a range of between about 1 to 5 percent by weight, compatibilizer in a range of between about 2 to 5 percent by weight.

12. The component of claim 11 wherein the composition comprises reinforcing material in a range of between about 40 to 60 percent by weight.

13. The component of claim 12 wherein the composition comprises less than about 1 percent by weight polyamide 6 (PA6).

14. The component of claim 1 wherein the composition comprises a polyketone composite material.

15. The component of claim 1 formed from the composition as an injection-molded component.

16. A method of producing of an injection-molded component providing a surface from a composition in a mold comprising the steps of:
(a) providing a polyketone resin comprising an aliphatic polyketone;
(b) adding the polyketone resin, a compatible resin, a copolymer resin, a compatibilizer and a reinforcing material into an extruder for polyketone modification to provide a reinforced polyketone composite material for the composition;
(c) adding the reinforced polyketone composite material into the mold; and
(d) forming the injection-molded component from the composition in the mold;
wherein the compatible resin is a resin providing compatibility with the polyketone resin;
wherein mass ratio of the polyketone resin is about 15 to 90 percent by weight, mass ratio of the compatible resin is about 1 to 10 percent by weight, mass ratio of the copolymer resin is about 1 to 10 percent by weight, mass ratio of the compatibilizer is about 1 to 5 percent by weight and mass ratio of the reinforcing material is about 5 to 60 percent by weight;
so that an effect on the surface of the injection-molded component is provided by the composition as a result of crystallinity and crystallization rate;
wherein crystallization rate is characterized by reciprocal of half-time of crystallization.

17. The method of claim 16 wherein mass ratio of the polyketone resin is about 25 to 44 percent by weight and mass ratio of the compatible resin is about 1 to 10 percent by weight and mass ratio of the copolymer resin is about 1 to 5 percent by weight and mass ratio of the compatibilizer is about 1 to 5 percent by weight and mass ratio of the reinforcing material is about 45 to 55 percent by weight.

18. The method of claim 16 wherein the composition comprises glass fiber; wherein crystallization rate is selected to reduce glass fiber exposure in the composition.

19. The method of claim 16 wherein the compatibilizer comprises a polyolefin grafted glycidyl methacrylate.

20. The method of claim 16 wherein crystallinity is determined in an isothermal measurement at 185 degrees Centigrade.
